(19) United States
(12) Patent Application Publication
(10) Pub. No.: US 2022/0068277 A1
(43) Pub. Date: Mar. 3, 2022

(54) METHOD AND APPARATUS OF PERFORMING VOICE INTERACTION, ELECTRONIC DEVICE, AND READABLE STORAGE MEDIUM

(71) Applicant: Beijing Baidu Netcom Science Technology Co., Ltd., Beijing (CN)

(72) Inventors: Zhijian WANG, Beijing (CN); Sheng QIAN, Beijing (CN)

(21) Appl. No.: 17/522,985

(22) Filed: Nov. 10, 2021

(30) Foreign Application Priority Data
Dec. 1, 2020 (CN) 202011388093.1

(51) Int. Cl. G10L 15/22; G10L 15/02; G10L 15/01

(52) U.S. Cl. CPC G10L 15/22; G10L 15/01; G10L 15/02

(57) ABSTRACT

The present disclosure provides a method and apparatus of performing a voice interaction, an electronic device and a readable storage medium, which relates to technical fields of voice processing and deep learning. The method of performing the voice interaction includes: acquiring an audio to be recognized; obtaining a recognition result for the audio to be recognized, by using an audio recognition model, and extracting an input of an output layer of the audio recognition model in a recognition process as a recognition feature; obtaining a response confidence level according to the recognition feature; and responding to the audio to be recognized, in response to determining that the response confidence level meets a preset response condition.

### CROSS-REFERENCE TO RELATED APPLICATION

This application claims priority Chinese Patent Application No. 202011388093.1, filed on Dec. 1, 2020, the content of which is incorporated herein by reference.

### TECHNICAL FIELD

The present disclosure relates to a field of computer technology, and in particular to a method and apparatus of performing a voice interaction, an electronic device and a readable storage medium in technical fields of voice processing and deep learning.

### BACKGROUND

When performing voice interaction, it is necessary to determine whether to respond to an audio through a confidence level of the audio in order to avoid a wrong response to the audio. The confidence level of the audio is generally obtained through a feature of the audio itself or a feature of a text corresponding to the audio. However, when the confidence level is obtained only by the audio or the text corresponding to the audio, an accuracy of the confidence level obtained is usually low, which causes the audio to be erroneously responded, so that response accuracy during the voice interaction is reduced.

### SUMMARY

The present disclosure provides a method of performing a voice interaction, including: acquiring an audio to be recognized; obtaining a recognition result for the audio to be recognized, by using an audio recognition model, and extracting an input of an output layer of the audio recognition model in a recognition process as a recognition feature; obtaining a response confidence level according to the recognition feature; and responding to the audio to be recognized, in response to determining that the response confidence level meets a preset response condition.

The present disclosure further provides an apparatus of performing a voice interaction, including: an acquisition unit configured to acquire an audio to be recognized; a recognition unit configured to obtain a recognition result for the audio to be recognized, by using an audio recognition model, and extract an input of an output layer of the audio recognition model in a recognition process as a recognition feature; a processing unit configured to obtain a response confidence level according to the recognition feature; and a response unit configured to respond to the audio to be recognized, in response to determining that the response confidence level meets a preset response condition.

The present disclosure further provides an electronic device, including: at least one processor; and a memory communicatively connected to the at least one processor, wherein the memory stores instructions executable by the at least one processor, and the instructions, when executed by the at least one processor, cause the at least one processor to implement the method described above.

The present disclosure further provides a non-transitory computer-readable storage medium having computer instructions stored thereon, wherein the computer instructions allow a computer to implement the method described above.

The present disclosure further provides a computer program product comprising an instruction processor, wherein the instruction processor is executable to implement the method described above.

Other effects of the optional manners described above will be described below in conjunction with specific embodiments.

### BRIEF DESCRIPTION OF THE DRAWINGS

The drawings are used to better understand the solution and do not constitute a limitation to the present disclosure.

FIG. 1 shows a schematic diagram according to a first embodiment of the present disclosure.

FIG. 2 shows a schematic diagram according to a second embodiment of the present disclosure.

FIG. 3 shows a schematic diagram according to a third embodiment of the present disclosure.

FIG. 4 shows a block diagram of an electronic device for implementing a method of performing a voice interaction according to the embodiments of the present disclosure.

### DETAILED DESCRIPTION OF EMBODIMENTS

The exemplary embodiments of the present disclosure are described below with reference to the drawings, which include various details of the embodiments of the present disclosure to facilitate understanding, and which should be considered as merely illustrative. Therefore, those ordinary skilled in the art should realize that various changes and modifications may be made to the embodiments described herein without departing from the scope and spirit of the present disclosure. In addition, for clarity and conciseness, descriptions of well-known functions and structures are omitted in the following description.

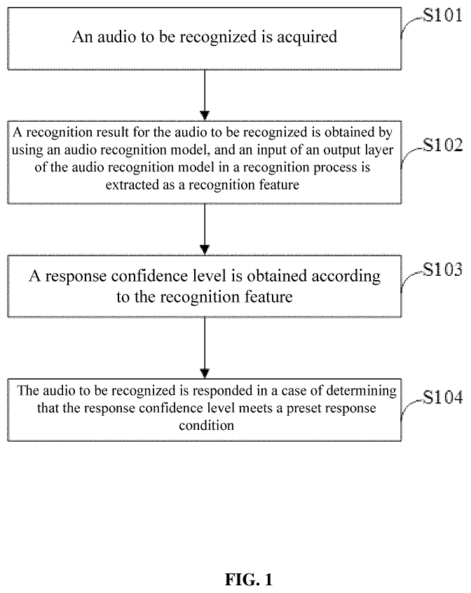

FIG. 1 shows a schematic diagram according to a first embodiment of the present disclosure. As shown in FIG. 1, the method of performing the voice interaction in this embodiment may specifically include following steps.

In step S101, an audio to be recognized is acquired.

In step S102, a recognition result for the audio to be recognized is obtained by using an audio recognition model, and an input of an output layer of the audio recognition model in a recognition process is extracted as a recognition feature.

In step S103, a response confidence level is obtained according to the recognition feature.

In S104, the audio to be recognized is responded in a case of determining that the response confidence level meets a preset response condition.

In the method of performing the voice interaction according to this embodiment, the response confidence level of the audio to be recognized is obtained by acquiring the recognition feature generated by the audio recognition model in the process of recognizing the audio to be recognized. Since the recognition feature acquired contains more abundant information, a more accurate response confidence level may be obtained. On the basis of improving the accuracy of the response confidence level, a wrong response to the audio to be recognized may be greatly avoided, so that the response accuracy of the voice interaction may be improved.

An execution subject of this embodiment may be a terminal device, including a smart phone, a smart home appliance, a smart speaker, or a vehicle voice interaction device, etc. The execution subject of this embodiment may also include a terminal device and a cloud server. After the terminal device transmits the audio to be recognized to the cloud server, the cloud server performs an audio recognition, then the response confidence level obtained according to the recognition feature is returned to the terminal device, and the terminal device determines whether to respond to the audio to be recognized, according to the response confidence level.

The audio to be recognized acquired in the step S101 in this embodiment is an audio generated by a user in the voice interaction with the terminal device. For example, the audio to be recognized may be a query audio sent by the user to the terminal device or a control audio sent by the user to the terminal device.

In this embodiment, after the step S101 is executed to acquire the audio to be recognized, step S102 is executed to obtain the recognition result for the audio to be recognized by using the audio recognition model, and extract the input of the output layer of the audio recognition model in the recognition process as the recognition feature.

The audio recognition model in this embodiment is a deep learning model, which includes a plurality of neural network layers used to output text according to the input audio. Therefore, the recognition result for the audio to be recognized obtained by using the audio recognition model in the step S102 in this embodiment is text.

Specifically, when the step S102 is executed to extract the input of the output layer of the audio recognition model in the recognition process as the recognition feature, an optional implementation may be adopted as follows. The audio recognition model includes an input layer, an attention layer and the output layer. The input layer is used to convert the input audio into a feature vector, the attention layer is used to perform an attention mechanism calculation on the feature vector of the input layer, and the output layer is used to map a calculation result output from the attention layer to text. The attention layer is located prior to the output layer in the audio recognition model, and the output of the attention layer in the recognition process is extracted as the recognition feature.

The attention layer in the audio recognition model in this embodiment may perform only one attention mechanism calculation, or may perform multiple attention mechanism calculations. In addition, a network structure of the audio recognition model is not limited in this embodiment. In addition to the network structure including the input layer, the attention layer and the output layer, the audio recognition model may also have a network structure including the input layer, a pooling layer, a convolutional layer and the output layer, or have a network structure including the input layer, the pooling layer, the convolution layer, the attention layer and the output layer.

That is to say, the recognition feature extracted in this embodiment is an output of a neural network layer located in a penultimate layer of the audio recognition model. Since the output of the neural network layer in the penultimate layer is used for the output layer to obtain the text, the output of this layer covers the most comprehensive information prior to a conversion of the audio into text. Compared with extracting features from audio only or text only, the recognition feature extracted in this embodiment may contain more abundant information, so that the accuracy of the recognition feature extracted is improved.

In this embodiment, after the step S102 is executed to obtain the recognition result and the recognition feature by using the audio recognition model, the step S103 is executed to obtain a response confidence level according to the recognition feature. The response confidence level obtained in this embodiment is used to determine whether to respond to the audio to be recognized.

When the step S103 is executed in this embodiment, the response confidence level may be obtained according to the recognition feature only. For example, the recognition feature may be input into a pre-trained deep learning model, and an output of the deep learning model may be taken as the response confidence level. The response confidence level may also be obtained by combining other information.

In this embodiment, after the step S103 is executed to obtain the response confidence level according to the recognition feature, the step S104 is executed to respond to the audio to be recognized in a case of determining that the response confidence level meets a preset response condition. In this embodiment, the response for the audio to be recognized may include acquiring a query result corresponding to the audio to be recognized, or performing an operation corresponding to the audio to be recognized.

In this embodiment, when the step S104 is executed to determine whether the response confidence level meets the preset response condition, it may be determined whether the response confidence level exceeds a preset threshold. If so, it is determined that the response confidence level meets the preset response condition. Otherwise, it is determined that the response confidence level does not meet the preset response condition.

In addition, if it is determined that the response confidence level does not meet the preset response condition in the step S104 of this embodiment, the audio to be recognized is not responded. The process may be suspended until the user inputs audio again, or prompt information may be provided to the user to remind the user to input the audio again.

According to the method provided in this embodiment, the response confidence level of the audio to be recognized is obtained by acquiring the recognition feature generated by the audio recognition model in the process of recognizing the audio to be recognized, and then whether to respond to the audio to be recognized is determined according to the response confidence level. Because the recognition feature contains more abundant information, a more accurate response confidence level may be obtained, so that a wrong response to the audio to be recognized may be avoided, and the response accuracy of the voice interaction is improved.

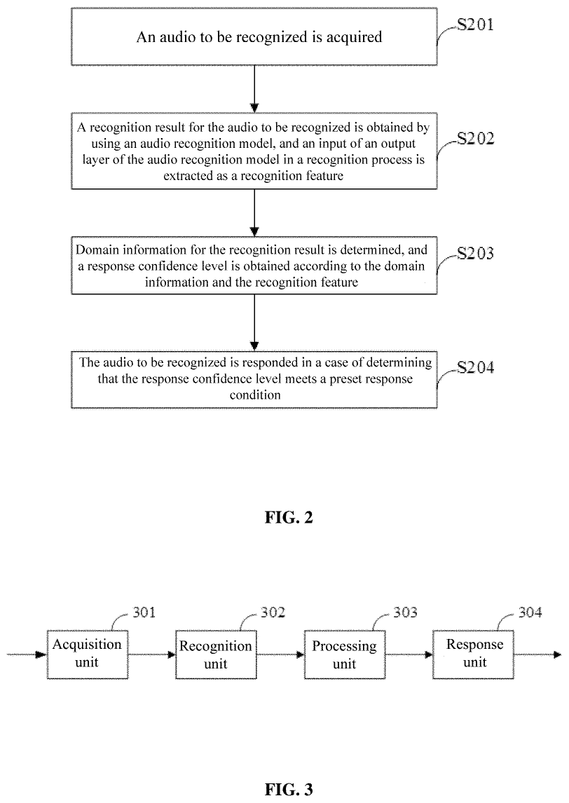

FIG. 2 shows a schematic diagram according to a second embodiment of the present disclosure. As shown in FIG. 2, the method of performing the voice interaction in this embodiment may specifically include following steps.

In S201, an audio to be recognized is acquired.

In step S202, a recognition result for the audio to be recognized is obtained by using an audio recognition model, and an input of an output layer of the audio recognition model in a recognition process is extracted as a recognition feature.

In step S203, domain information for the recognition result is determined, and a response confidence level is obtained according to the domain information and the recognition feature.

In step S204, the audio to be recognized is responded in a case of determining that the response confidence level meets a preset response condition.

That is to say, in the method of performing the voice interaction according to this embodiment, the response confidence level of the audio to be recognized is obtained by acquiring the recognition feature generated by the audio recognition model in the process of recognizing the audio to be recognized, in combination with the domain information associated with the recognition result for the audio to be recognized. In this way, the information for obtaining the response confidence level is more abundant, and the accuracy of the response confidence level is further improved, so that the response accuracy of the voice interaction is improved.

The domain information for the recognition result determined in the step S203 in this embodiment is used to indicate a domain to which the recognition result belongs, such as finance, technology, music, etc.

Specifically, when the step S203 in this embodiment is executed to determine the domain information for the recognition result, an optional implementation may be adopted as follows. The recognition result is input into a pre-trained domain recognition model, and an output result of the domain recognition model is taken as the domain information for the recognition result. In this embodiment, the domain recognition model is pre-trained so that the domain recognition model may output the domain information associated with a text input.

In addition, when the step S104 in this embodiment is executed to obtain the response confidence level according to the domain information and the recognition feature, an optional implementation may be adopted as follows. The domain information and the recognition feature are input into a pre-trained confidence model, and an output result of the confidence model is taken as the response confidence level. In this embodiment, the confidence model is pre-trained so that the confidence model may output the response confidence level associated with the audio according to the input domain information and the input recognition feature.

Therefore, in this embodiment, the response confidence level of the audio to be recognized may be obtained by combining the domain information and the recognition feature, so that the accuracy of the response confidence level may be improved.

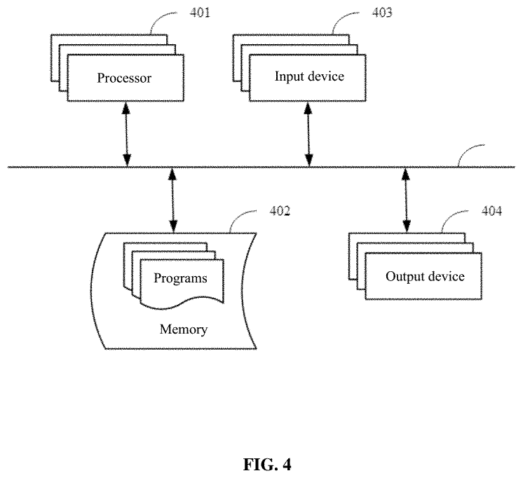

FIG. 3 shows a schematic diagram according to a third embodiment of the present disclosure. As shown in FIG. 3, an apparatus of performing a voice interaction in this embodiment includes: an acquisition unit 301 used to acquire an audio to be recognized; a recognition unit 302 used to obtain a recognition result for the audio to be recognized, by using an audio recognition model, and extract an input of an output layer of the audio recognition model in a recognition process as a recognition feature; a processing unit 303 used to obtain a response confidence level according to the recognition feature; and a response unit 304 used to respond to the audio to be recognized, in response to determining that the response confidence level meets a preset response condition.

The audio to be recognized acquired by the acquisition unit 301 in this embodiment is an audio generated by the user in the voice interaction with the terminal device. For example, the acquisition unit 301 may acquire a query audio sent by the user to the terminal device or a control audio sent by the user to the terminal device.

In this embodiment, after the acquisition unit 301 acquires the audio to be recognized, the recognition unit 302 may obtain the recognition result for the audio to be recognized, by using the audio recognition model, and extract the input of the output layer of the audio recognition model in the recognition process as the recognition feature.

The audio recognition model in this embodiment is a deep learning model, which includes a plurality of neural network layers used to output text according to the input audio. Therefore, the recognition result for the audio to be recognized obtained by the recognition unit 302 by using the audio recognition model is text.

Specifically, in this embodiment, when the recognition unit 302 extracts the input of the output layer of the audio recognition model in the recognition process as the recognition feature, an optional implementation may be adopted as follows. The audio recognition model includes an input layer, an attention layer and the output layer. The attention layer is located prior to the output layer in the audio recognition model, and the output of the attention layer in the recognition process is extracted as the recognition feature.

The attention layer in the audio recognition model of this embodiment may perform only one attention mechanism calculation, or may perform multiple attention mechanism calculations. In addition, a network structure of the audio recognition model is not limited in this embodiment. In addition to the network structure including the input layer, the attention layer and the output layer, the audio recognition model may also have a network structure including the input layer, a pooling layer, a convolutional layer and the output layer, or have a network structure including the input layer, the pooling layer, the convolution layer, the attention layer and the output layer.

In this embodiment, after recognition unit 302 obtains the recognition result and the recognition feature by using the audio recognition model, the processing unit 303 may obtain the response confidence level according to the recognition feature. The response confidence level obtained in this embodiment is used to determine whether to respond to the audio to be recognized.

The processing unit 303 in this embodiment may obtain the response confidence level according to the recognition feature only. For example, the recognition feature may be input into a pre-trained deep learning model, and an output of the deep learning model may be taken as the response confidence level. The response confidence level may also be obtained by combining other information.

When the processing unit 303 in this embodiment obtains the response confidence level according to the recognition feature, an optional implementation may be adopted as follows. The domain information for the recognition result is determined, and the response confidence level is obtained according to the domain information and the recognition feature.

In this embodiment, the domain information determined by the processing unit 303 according to the recognition result is used to indicate a domain to which the recognition result belongs, such as finance, technology, music, etc.

Specifically, when the processing unit 303 in this embodiment determines the domain information for the recognition result, an optional implementation may be adopted as follows. The recognition result is input into a pre-trained domain recognition model, and an output result of the domain recognition model is taken as the domain information for the recognition result. In this embodiment, the domain recognition model is pre-trained so that the domain recognition model may output the domain information associated with a text input.

In addition, when the processing unit 303 in this embodiment obtains the response confidence level according to the domain information and the recognition feature, an optional implementation may be adopted as follows. The domain information and the recognition feature are input into a pre-trained confidence model, and an output result of the confidence model is taken as the response confidence level. In this embodiment, the confidence model is pre-trained so that the confidence model may output the response confidence level associated with the audio according to the input domain information and the input recognition feature.

In this embodiment, after the processing unit 303 obtains the response confidence level, the response unit 304 may respond to the audio to be recognized in a case of determining that the response confidence level meets a preset response condition. In this embodiment, the response for the audio to be recognized may include acquiring a query result corresponding to the audio to be recognized, or performing an operation corresponding to the audio to be recognized.

In this embodiment, when the response unit 304 determines whether the response confidence level meets the preset response condition, the response unit 304 may determine whether the response confidence level exceeds a preset threshold. If so, it is determined that the response confidence level meets the preset response condition. Otherwise, it is determined that the response confidence level does not meet the preset response condition.

In addition, if the response unit 304 in this embodiment determines that the response confidence level does not meet the preset response condition, the audio to be recognized is not responded. The process may be suspended until the user inputs audio again, or prompt information may be provided to the user to remind the user to input the audio again.

According to the embodiments of the present disclosure, the present disclosure further provides an electronic device, a computer-readable storage medium, and a computer program product.

FIG. 4 shows a block diagram of an electronic device for implementing the method of performing the voice interaction according to the embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 4, the electronic device may include one or more processors 401, a memory 402, and interface(s) for connecting various components, including high-speed interface(s) and low-speed interface(s). The various components are connected to each other by using different buses, and may be installed on a common motherboard or installed in other manners as required. The processor may process instructions executed in the electronic device, including instructions stored in or on the memory to display graphical information of GUI (Graphical User Interface) on an external input/output device (such as a display device coupled to an interface). In other embodiments, a plurality of processors and/or a plurality of buses may be used with a plurality of memories, if necessary. Similarly, a plurality of electronic devices may be connected in such a manner that each device providing a part of necessary operations (for example, as a server array, a group of blade servers, or a multi-processor system). In FIG. 4, a processor 401 is illustrated by way of example.

The memory 402 is a non-transitory computer-readable storage medium provided by the present disclosure. The memory stores instructions executable by at least one processor, to cause the at least one processor to perform the method of performing the voice interaction provided in the present disclosure. The non-transitory computer-readable storage medium of the present disclosure stores computer instructions for allowing a computer to execute the method of performing the voice interaction provided in the present disclosure.

The memory 402, as a non-transitory computer-readable storage medium, may be used to store non-transitory software programs, non-transitory computer-executable programs and modules, such as program instructions/modules corresponding to the method of performing the voice interaction in the embodiments of the present disclosure (for example, the acquisition unit 301, the recognition unit 302, the processing unit 303 and the response unit 304 shown in FIG. 3). The processor 401 executes various functional applications and data processing of the server by executing the non-transient software programs, instructions and modules stored in the memory 402, thereby implementing the method of performing the voice interaction in the embodiments of the method mentioned above.

The memory 402 may include a program storage area and a data storage area. The program storage area may store an operating system and an application program required by at least one function. The data storage area may store data etc. generated by using the electronic device according to the method of performing the voice interaction. In addition, the memory 402 may include a high-speed random access memory, and may further include a non-transitory memory, such as at least one magnetic disk storage device, a flash memory device, or other non-transitory solid-state storage devices. In some embodiments, the memory 402 may optionally include a memory provided remotely with respect to the processor 401, and such remote memory may be connected through a network to the electronic device for implementing the method of performing the voice interaction. Examples of the above-mentioned network include, but are not limited to the Internet, intranet, local area network, mobile communication network, and combination thereof.

The electronic device for implementing the method of performing the voice interaction may further include an input device 403 and an output device 404. The processor 401, the memory 402, the input device 403 and the output device 404 may be connected by a bus or in other manners. In FIG. 4, the connection by a bus is illustrated by way of example.

The input device 403 may receive input information of numbers or character, and generate key input signals related to user settings and function control of the electronic device for implementing the method of performing the voice interaction, such as a touch screen, a keypad, a mouse, a track pad, a touchpad, a pointing stick, one or more mouse buttons, a trackball, a joystick, and so on. The output device 404 may include a display device, an auxiliary lighting device (for example, LED), a tactile feedback device (for example, a vibration motor), and the like. The display device may include, but is not limited to, a liquid crystal display (LCD), a light emitting diode (LED) display, and a plasma display. In some embodiments, the display device may be a touch screen.

Various embodiments of the systems and technologies described herein may be implemented in a digital electronic circuit system, an integrated circuit system, an application specific integrated circuit (ASIC), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from the storage system, the at least one input device and the at least one output device, and may transmit the data and instructions to the storage system, the at least one input device, and the at least one output device.

These computing programs (also referred as programs, software, software applications, or codes) include machine instructions for a programmable processor, and may be implemented using high-level programming languages, object-oriented programming languages, and/or assembly/machine languages. As used herein, the terms “machine-readable medium” and “computer-readable medium” refer to any computer program product, apparatus and/or device (for example, magnetic disk, optical disk, memory, programmable logic device (PLD)) for providing machine instructions and/or data to a programmable processor, including a machine-readable medium for receiving machine instructions as machine-readable signals. The term “machine-readable signal” refers to any signal for providing machine instructions and/or data to a programmable processor.

In order to provide interaction with the user, the systems and technologies described here may be implemented on a computer including a display device (for example, a CRT (cathode ray tube) or LCD (liquid crystal display) monitor) for displaying information to the user), and a keyboard and a pointing device (for example, a mouse or a trackball) through which the user may provide the input to the computer. Other types of devices may also be used to provide interaction with users. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), Internet, and a blockchain network.

The computer system may include a client and a server. The client and the server are generally far away from each other and usually interact through a communication network. The relationship between the client and the server is generated through computer programs running on the corresponding computers and having a client-server relationship with each other. The server may be a cloud server, also known as a cloud computing server or a cloud host. It is a host product in the cloud computing service system to solve shortcomings of difficult management and weak business scalability existing in the traditional physical host and VPS (Virtual Private Server) service. The server may also be a server of a distributed system or a server combined with a blockchain.

According to the technical solutions of the embodiments of the present disclosure, the response confidence level of the audio to be recognized is obtained by acquiring the recognition feature generated by the audio recognition model in the process of recognizing the audio to be recognized. Because the recognition feature acquired contains more abundant information, a more accurate response confidence level may be obtained. On the basis of improving the accuracy of the response confidence level, a wrong response to the audio to be recognized may be greatly avoided, so that the response accuracy of the voice interaction is improved.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the protection scope of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A method of performing a voice interaction, comprising:
acquiring an audio to be recognized;
obtaining a recognition result for the audio to be recognized, by using an audio recognition model, and extracting an input of an output layer of the audio recognition model in a recognition process as a recognition feature;
obtaining a response confidence level according to the recognition feature; and
responding to the audio to be recognized, in response to determining that the response confidence level meets a preset response condition.

2. The method of claim 1, wherein the audio recognition model comprises an input layer, an attention layer and the output layer, and wherein the extracting an input of an output layer of the audio recognition model in a recognition process as a recognition feature comprises:
extracting an output of the attention layer in the recognition process as the recognition feature, wherein the attention layer is located prior to the output layer in the audio recognition model.

3. The method of claim 1, wherein the obtaining a response confidence level according to the recognition feature comprises:
determining a domain information for the recognition result; and
obtaining the response confidence level according to the domain information and the recognition feature.

4. The method of claim 3, wherein the determining a domain information for the recognition result comprises:
inputting the recognition result into a pre-trained domain recognition model, and taking an output result from the domain recognition model as the domain information for the recognition result.

5. The method of claim 3, wherein the obtaining the response confidence level according to the domain information and the recognition feature comprises:
inputting the domain information and the recognition feature into a pre-trained confidence model, and taking an output result from the pre-trained confidence model as the response confidence level.

6. An electronic device, comprising:
at least one processor; and
a memory communicatively connected to the at least one processor, wherein the memory stores instructions executable by the at least one processor, and the instructions, when executed by the at least one processor, cause the at least one processor to implement voice interaction operations, comprising:
acquiring an audio to be recognized;
obtaining a recognition result for the audio to be recognized, by using an audio recognition model, and extracting an input of an output layer of the audio recognition model in a recognition process as a recognition feature;
obtaining a response confidence level according to the recognition feature; and
responding to the audio to be recognized, in response to determining that the response confidence level meets a preset response condition.

7. The electronic device of claim 6, wherein the instructions, when executed by the at least one processor, further cause the at least one processor to implement operations of:
extracting an output of the attention layer in the recognition process as the recognition feature, wherein the attention layer is located prior to the output layer in the audio recognition model.

8. The electronic device of claim 6, wherein the instructions, when executed by the at least one processor, further cause the at least one processor to implement operations of:
determining a domain information for the recognition result; and
obtaining the response confidence level according to the domain information and the recognition feature.

9. The electronic device of claim 6, wherein the instructions, when executed by the at least one processor, further cause the at least one processor to implement operations of:
inputting the recognition result into a pre-trained domain recognition model, and taking an output result from the domain recognition model as the domain information for the recognition result.

10. The electronic device of claim 6, wherein the instructions, when executed by the at least one processor, further cause the at least one processor to implement operations of:
inputting the domain information and the recognition feature into a pre-trained confidence model, and taking an output result from the pre-trained confidence model as the response confidence level.

11. A non-transitory computer-readable storage medium having computer instructions stored thereon, wherein the computer instructions allows a computer to implement voice interaction operations, comprising:
acquiring an audio to be recognized;
obtaining a recognition result for the audio to be recognized, by using an audio recognition model, and extracting an input of an output layer of the audio recognition model in a recognition process as a recognition feature;
obtaining a response confidence level according to the recognition feature; and
responding to the audio to be recognized, in response to determining that the response confidence level meets a preset response condition.

12. The storage medium of claim 11, wherein the computer instructions further allows the computer to implement operations of:
extracting an output of the attention layer in the recognition process as the recognition feature, wherein the attention layer is located prior to the output layer in the audio recognition model.

13. The storage medium of claim 11, wherein the computer instructions further allows the computer to implement operations of:
determining a domain information for the recognition result; and
obtaining the response confidence level according to the domain information and the recognition feature.

14. The storage medium of claim 11, wherein the computer instructions further allows the computer to implement operations of:
inputting the recognition result into a pre-trained domain recognition model, and taking an output result from the domain recognition model as the domain information for the recognition result.

15. The storage medium of claim 11, wherein the computer instructions further allows the computer to implement operations of:
inputting the domain information and the recognition feature into a pre-trained confidence model, and taking an output result from the pre-trained confidence model as the response confidence level.
